(19) United States
(12) Patent Application Publication
(10) Pub. No.: US 2004/0035236 A1
(43) Pub. Date: Feb. 26, 2004

(54) Windshield wiper device and method for making a worm gear, in particular, for a windshield wiper device for a motor vehicle

(76) Inventors: Armin Stubner, Buehl-Altschweier (DE); Richard Hurst, Offenburg (DE); Claus Fleischer, Buehl (DE); Johannes Moosmann, Freiburg (DE)

Correspondence Address: STRIKER, STRIKER & STENBY, 103 East Neck Road, Huntington, NY, 11743, US

(21) Appl. No.: 10/446,222

(22) Filed: May 28, 2003

(30) Foreign Application Priority Data
Aug. 21, 2002 (DE) 102 39 178.5

(51) Int. Cl. F16H 1/16

(52) U.S. Cl. 74/425

(57) ABSTRACT

A windshield wiper device (10), in particular, for a motor vehicle, includes a drive (12) and a worm drive (14) with a worm (16). A worm gear (18) with a toothing (24) is provided, which includes a base body (22) on which the toothing (24) is sprayed. In addition, a method for making such a windshield wiper device is provided.

### BACKGROUND OF THE INVENTION

The present application relates to a windshield wiper device with a worm gear and a method for making a worm gear.

Already, numerous windshield wiper devices are known, in which a drive is provided, which drives a worm drive with a worm and a worm gear. With this type of windshield wiper device, the worm gear normally is made from plastic and sputtered on a drive shaft. Shrinking and distortion limit the tolerancing with regard to size and shape accuracy, whereby the efficiency and wear of the worm gear are negative affected. At the same time, very high requirements exist on the worm gear with reference to the stability and temperature dependency, which can be resolved by metallic worm gears or worm gears made from specialized materials, which, however, are either very expense or cause a high weight.

### SUMMARY OF THE INVENTION

The windshield wiper of the present invention has the advantage that by means of a base body, on which the toothing is sprayed, a two-component gear wheel is made, which has a high tolerance accuracy, position accuracy, and shape accuracy and in spite of these features, realizes a low weight with minimal costs.

It is particularly advantageous if the base body is made from a metal, in particular, from steel. Through the metallic base body, whose has a high durability, a very hard-wearing gear wheel can be made and the use of high-strength, temperature-resistant, and cost-intensive materials are reduced to a minimum.

If the teeth are made of plastic, the worm gear has a low weight and therefore, in addition, causes only minimal operational noise.

It is particularly advantageous if the worm gear includes only one segment. In this manner, weight and material can be saved, since only the required region of the worm gear must be produced. This is particularly true if the drive of the windshield wiper device is embodied as a reversing electric motor.

An improved moment of rotation transmission is achieved when the base body has elements that engaged in the teeth of the toothing.

In addition, it is advantageous if the base body is connected form and/or positively connected with a drive shaft.

As a further advantage, the manufacturing tolerances of the base body can be compensated by means of the spraying of the toothing.

In addition, it is advantageous that the contact surface between the sprayed toothing and the base body has a greater distance to the axis of rotation of the worm gear than with conventional worm gears. In addition, with the same dimensions, minimal tension in the contact surfaces between the base body and the sprayed toothing are provided.

### BRIEF DESCRIPTION OF THE DRAWINGS

FIG. 1 shows the windshield wiper device of the present invention in cross section;

FIG. 2 shows the worm gear of the inventive windshield wiper device in a schematic representation;

FIG. 3 shows the worm gear of FIG. 2 in a sectional view;

FIG. 4 shows a variation of the inventive worm gear; and

FIG. 5 shows a schematic illustration of the method steps of the manufacturing method of the present invention.

### DETAILED DESCRIPTION OF THE PREFERRED EMBODIMENTS

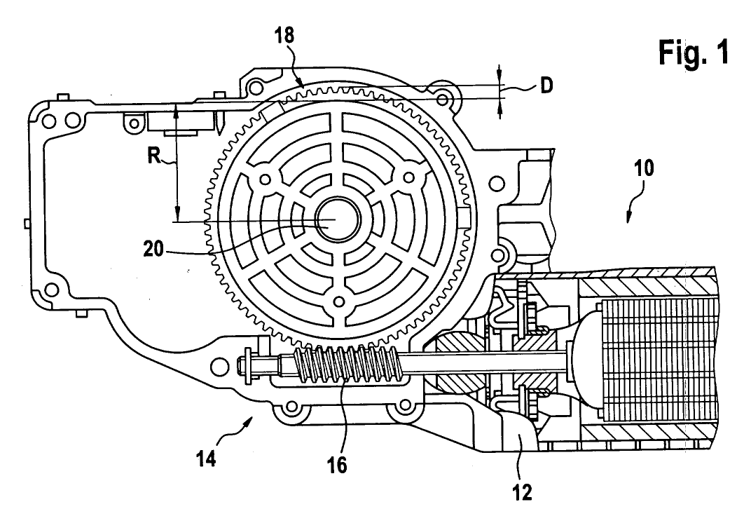

FIG. 1 shows the windshield wiper device 10 of the present invention in cross section.

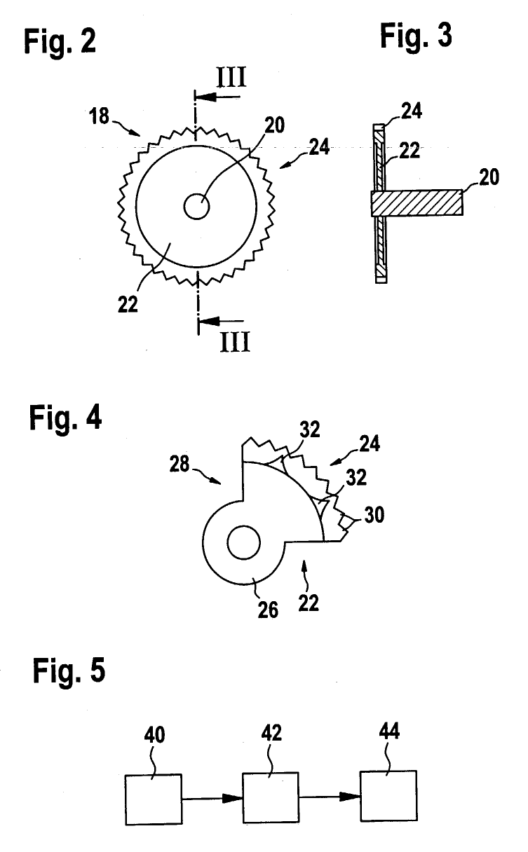

The windshield wiper device 10 includes a drive 12, which drives a worm drive 14 with a worm 16 and a worm gear 18. The worm gear 18 is connected with a drive shaft 20, which typically is extrusion-coated from a worm gear sprayed from plastic. The worm gear 18 comprises essentially a base body 22, which is extruded around the drive shaft 20 and is made of metal, preferably steel. Around the base body 22, the toothing 24 of a high-strength and temperature-resistant plastic is sprayed on. The radius R of the base body 22 is hereby essentially larger than the thickness D of the toothing 24. In FIG. 2, the worm gear 18 is shown again in detail. In the center of the worm gear 18, a drive shaft 20 is disposed, which is connected with the base body 22. Around the base body 22, the plastic toothing 24 is sprayed on.

In FIG. 3, a section through the worm gear 18 of FIG. 2 is shown. The drive shaft 20 is arranged in the center of the base body 22 of the worm gear 20. The toothing 24 is sprayed on the base body. The drive shaft 20 is made of a metal, like the base body 22, for example, steel, aluminum, or zinc and has a high stability. The toothing 24 is made from a high-strength, temperature-resistant plastic.

In FIG. 4, one variation of the worm gear of FIG. 2 is shown. The base body 22 here is no longer circularly-symmetric, rather includes merely a circular ring 26, which surrounds the drive shaft 20 and on which a segment 28 is formed. Naturally, the circular ring 26 also can be formed as one piece with the segment 28, on which the toothing 24 is sprayed. The toothing 24 includes here only the segment section, which is predetermined through the segment 28. In this manner, a pitch circle cog wheel or gear is provided, which, however, with a pendulum movement of the drive shaft 20, for example, in the case of a reversing electric motor, is satisfactory.

The drive shaft 20 also can be provided with a polyhedral configuration, for example, square, hexagonal or knurl, so that upon assembling or spraying of the base body 22 on the drive shaft 20, not only a force positive connection, but also a form fit are provided. In this manner, even higher moments of rotation can be transmitted to the drive shaft 20.

In FIG. 5, a schematic representation of the inventive method for making a worm gear is shown.

The toothing 24 is essentially formed by means of a circular-ring shaped body, which is bordered by teeth 30 on its outer side. The base body 22 here, for example, can have one or more elements 32 which engage in the toothing 24 and/or in one or more teeth 30 in order to increase the moment of rotation transfer between the base body 22 and the toothing 24.

In a first step 40, the drive shaft 20 is inserted into a mold and extrusion-coated with metal, so that the base body 22 is generated. The base body produced in this manner is placed in a further injection mold in a second step 42 and aligned. In a third step 44, the-toothing 24 is sprayed onto the base body 22.

It will be understood that each of the elements described above, or two or more together, may also find a useful application in other types of constructions differing from the types described above.

While the invention has been illustrated and described herein as a windshield wiper device with a worm gear and a method for making a worm gear, in particular, for a windshield wiper device for a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Windshield wiper device (10), in particular for a motor vehicle, with a drive (12) and a worm drive (14) with a worm (16), characterized in that a worm gear (18) with a toothing (24) is provided, which includes a base body (22), on which the toothing (24) is sprayed.

2. Windshield wiper device (10) according to claim 1, characterized in that the base body (22) is made from a metal, in particular, from steel.

3. Windshield wiper device (10) according to claim 1, characterized in that the toothing (24) is made from plastic.

4. Windshield wiper device (10) according to claim 1, characterized in that the worm gear (18) includes only one segment (26).

5. Windshield wiper device (10) according to claim 1, characterized in that the toothing (24) has teeth (30) and the base body (22) has element (32) that engaged in at least one tooth (30).

6. Windshield wiper device (10) according to claim 1, characterized in that the base body (22) is connected in a positive-fit and/or force-fit manner with a drive shaft (20).

7. Method for making a worm gear (18), in particular, for a windshield wiper device (10) according to claim 1, with a base body (22) and a toothing (24), characterized by the following steps:
making the base body (40);
placing the base body (42) into an injection mold; and
spraying on the toothing (44).

8. Method according to claim 7, characterized in that the base body (22) is provided with a drive shaft (20) before spraying on of the toothing (24).
